(19) United States
(12) Patent Application Publication
(10) Pub. No.: US 2006/0098304 A1
(43) Pub. Date: May 11, 2006

(54) Panoramic objective and panoramic camera

(76) Inventor: Alexander Wuerz-Wessel, Stuttgart (DE)

Correspondence Address: AKERMAN SENTERFITT, 222 LAKEVIEW AVENUE, SUITE 400, P.O. BOX 3188, WEST PALM BEACH, FL, 33401, US

(21) Appl. No.: 10/535,303

(22) PCT Filed: Dec. 1, 2003
(86) PCT No.: PCT/EP03/13481

§ 371 Date: May 17, 2005

(30) Foreign Application Priority Data
Dec. 5, 2002 (DE) 102 56 794.8

(51) Int. Cl. G02B 13/06

(52) U.S. Cl. 359/725

(57) ABSTRACT

The invention relates to a photographic objective comprising a first (4) and at least one second mirror (5) and at least one lens (8). A barrel (7, 11), inside of which the lens (8) is anchored, is formed by a supporting body (3) of the first mirror (4).

### BACKGROUND OF THE INVENTION

1. Field of the Invention

The present invention relates to an objective which uses both mirrors and lenses for image formation, and to a camera exhibiting such an objective.

2. Related Art of the Invention

Non-planar imaging mirrors have long been used in photographic objectives for extremely long focal lengths, since they make it possible to make these objectives much shorter than they would be according to their focal length, thus considerably reducing the weight of such an objective in comparison with a corresponding objective in lens optics and improving its manageability.

In recent years, numerous constructions of objectives having extremely wide visual angles up to a panoramic view of 360° have been proposed which use non-planar mirror surfaces as imaging elements. An overview of the constructions of such objectives and the types of mirror surfaces used in these is given in the article “Folded Catadioptric Cameras” by S. K. Nayar and V. Peri, in Proceedings of Conference on Computer Vision and Recognition (CVPR), Vol. 2, IEEE, pages 217 ff.

From WO 00/41024, an objective is known in which two mirrors are formed on boundary faces of a transparent body, the central area of the first mirror remaining without reflecting coating so that rays can reach a lens system through this central area, and in which the shape of the central area is different from the surrounding mirror surface in order to take into account refractive effects of the transparent bodies.

Objectives with mirror and lens optics are usually implemented by first providing the lens optics as a complete assembly and then attaching the mirrors to this via a holder. The lens optics are frequently an objective which can operate as such. Due to the size of this objective and the necessary distance from the mirrors predetermined by the size and focal length of the objective, there are limits to the miniaturization of such a combined mirror/lens objective. In addition, due to the optical characteristics of the mirrors, the lens-optical objective must be defocused in a defined manner so that the total arrangement creates a sharp image. This represents an adjustment effort.

### SUMMARY OF THE INVENTION

It is the object of the invention to specify a photographic objective with mirrors and at least one lens which can be fabricated in a simple and inexpensive manner and is well suited to miniaturization.

This object is achieved by an objective having the features of claim 1. Simplification and a miniaturization capability are achieved by the fact that a supporting body, on which the first mirror is formed, is used at the same time as barrel for holding the at least one lens. The lens is not, therefore, surrounded by a separate barrel increasing the space requirement of the objective as in conventional lens optics forming an independent constructional unit.

According to a first preferred embodiment of the invention, not only the barrel which holds the lens but also the lens itself is constructed of one piece with the support material for the mirror. This allows the supporting body of the mirror and the lens to be produced in a simple and inexpensive manner in one operating cycle, e.g. by plastic injection molding.

According to a second preferred embodiment, the lens is produced separately from the supporting body of the mirror and inserted into the barrel formed in the supporting body. This facilitates fine machining of the refractive surfaces of the lens before insertion, e.g. by polishing, applying an antireflection coating etc.

The lens attached in this manner in the barrel of the mirror can be, in particular, the front lens of a lens system. Other lenses of such a lens system which generally have a smaller diameter than the front lens can be mounted in an intermediate barrel which is inserted into the barrel formed by the mirror.

The lens is preferably recessed behind the surface of the first mirror, i.e. there is a section of the barrel which extends between the surface of the first mirror and lens and which can act as a baffle for the lens.

To enable the lens to be assembled standing back like that, a hyperboloid is preferably selected as the first mirror, which is constructed in the form of a paraboloid, ellipsoid or in a general form of rotational conic section.

### BRIEF DESCRIPTION OF THE DRAWINGS

Further features and advantages of the invention are obtained from the subsequent descriptions of exemplary embodiments, referring to the attached drawings, in which:

FIG. 1 shows a diagrammatic section through a mirror-lens objective according to a first embodiment of the present invention;

FIG. 2 shows an enlarged detail of a variant of this first embodiment; and

FIGS. 3, 4 show sections through mirror-lens objectives according to further embodiments of the invention.

### DETAILED DESCRIPTION OF THE INVENTION

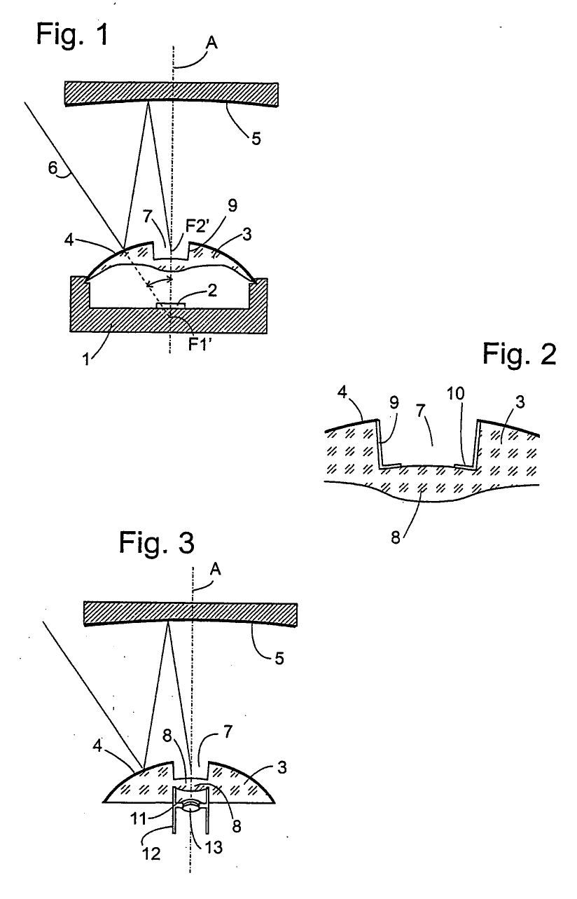

FIG. 1 shows a diagrammatic section through a camera comprising a mirror-lens objective according to a first embodiment of the invention. The camera comprises a cup-like housing 1 with a light-sensitive element such as CCD (Charge Coupled Device) 2 arranged on the optical axis A. The housing is closed at its top by a supporting body 3 of a transparent material in optical quality. The supporting body 3 has an outside surface in the form of a convex rotational hyperboloid symmetrical about the optical axis A, on which an aluminum or silver layer is vapour-deposited in order to form a first mirror 4. At a distance above the first mirror 4, a second mirror 5 is arranged which here takes the form of a concave rotational hyperboloid. Light rays 6, which are incident on the first mirror 1 at arbitrary azimuth angles and from a wide range of zenith angles θ are reflected from the first mirror 1 to the second mirror 5 and from there into a central recess 7 of the supporting body 3 in which a lens 8 is arranged of one piece with the supporting body 3, which projects an image of the surroundings onto the CCD 2.

The lens is protected against grazingly incident scattered light by the position of the lens 8 which is recessed with respect to the surface of the mirror 4. Such scattered light can only reach the side wall 9 of the recess 7. To avoid the scattered light from being reflected from there onto the lens 8, the side wall 9 can be blackened.

To improve the optical characteristics, the lens 8 can be provided with an antireflection coating. This can also be applied to the side wall 9 instead of blackening, in order to protect the lens 8 against scattered light. This has the effect that scattered light incident onto the side wall 9 virtually completely enters into the supporting body 3 behind the first mirror 4 and is removed by total reflection within the supporting body 3 towards its outer edges.

Since in the exemplary embodiment of FIG. 1, both mirrors 4, 5 are hyperboloids, the secondary focus F2′ of the second mirror 5 is located beyond the mirror 4, i.e. in the recess 7. To be able to image this secondary focus F2′ on the CCD chip 2 with the aid of the lens 8, the latter must, therefore, also be arranged recessed with respect to the surface of the first mirror 4 on the bottom of the recess 7 even below the secondary focus F2′.

As shown in FIG. 1, the surface of the lens 8 facing the CCD chip 2 is raised above adjoining areas of the rear of the supporting body 3 and can, therefore, be polished without problems in order to improve the quality of the surface if it cannot already be obtained with sufficient quality during the original shaping. Due to its position, however, the surface of the lens 8 forming the bottom of the recess 7 is difficult to polish at least in its edge regions. To prevent faults in the lens 8 from impairing the imaging characteristics in these edge areas, it can be provided that the aforementioned black layer is applied not only for suppressing scattered light on the side wall 9 of the recess 7 but also in those edge regions of the lens 8 in which an adequate surface quality cannot be achieved with sufficient reliability. This is shown by way of example in FIG. 2 which shows an enlarged section through the central area of the supporting body 3 and the lens 8, the absorbing black layer being designated by 10.

FIG. 3 shows a further development of the camera from FIG. 1. The housing 1 and the CCD chip 2 are not shown again in FIG. 3 since they do not differ from those of FIG. 1.

In the embodiment of FIG. 3, the lens 8 constructed of one piece with the supporting body 3 is not raised above the rear of the supporting body 3 but, instead, the rear of the supporting body 3 here also exhibits a recess 11, the bottom of which is formed by the rear of the lens 8. The two cylindrical recesses 7, 11, which are aligned with one another, can be considered to be two parts of an optical barrel which extends along the optical axis A and in which the lens 8 is held. The recess 11 is here used at the same time as a plug-in mount into which an intermediate barrel 12 is inserted which, in turn, contains a number of further lenses 13. The lens 8, which is of one piece with the supporting body 3, and the lenses 13 of the intermediate barrel 12 form a lens objective. Since the lens 8 which, as the front lens, is the largest lens of this lens objective, is not held in the intermediate barrel 12, the diameter of the intermediate barrel 12 does not need to exceed that of the front lens which provides for a compact type of construction of the entire objective.

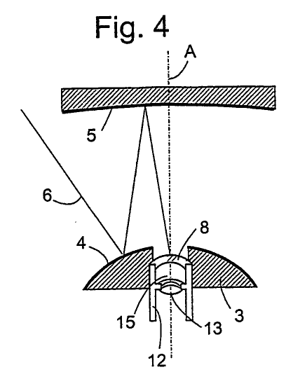

FIG. 4 shows a further embodiment of the mirror-lens objective according to the invention in which the lens 8 is not constructed of one piece with the supporting body 3 of the first mirror 4 but this supporting body 3 exhibits a through hole 15 with an inner shoulder which represents a barrel for holding the lens 8. In the embodiment of FIG. 4, the barrel 15 is widened at the side of the shoulder 14 facing away from the mirror 4 so that the lens 8 and an intermediate barrel 12 carrying further lenses 13 can be inserted from the rear of the supporting body 3 and attached in the supporting body 3. This design allows the lens 8 to be manufactured, polished and coated separately from the supporting body 3 so that it can exhibit an excellent optical quality over its entire surface, and to be mounted only subsequently in the barrel 15 of the supporting body 3. In consequence, there is also no need for the supporting body 3 to be entirely manufactured of a transparent material of optical quality; like that of the second mirror 5, it may consist of a transparent material whose optical characteristics are not subject to any requirements.

1. A photographic objective comprising a first (4) and at least one second mirror (5) and at least one lens (8), wherein a barrel (7; 7, 11; 15), in which the lens (8) is anchored, is formed by a supporting body (3) of the first mirror (4) wherein, with the exception of its front lens (8), the lenses (13) of a lens system are mounted in an intermediate barrel (12) which is inserted into the barrel (11; 15) of the mirror (3).

2. The photographic objective as claimed in claim 1, wherein the mirrors (4, 5) and the lens (8) have a common optical axis A.

3. The photographic objective as claimed in claim 1 or 2, wherein the beam path in the objective extends from the first mirror (4) via the second mirror (5) to the lens (8).

4. The photographic objective as claimed in one of the preceding claims, wherein the lens (8) is recessed behind the surface of the first mirror (4).

5. The photographic objective as claimed in one of the preceding claims, wherein at least the first mirror (4) is a hyperboloid.

6. The photographic objective as claimed in one of the preceding claims, wherein the lens (8) is constructed of one piece with the supporting body (4) of the first mirror (1).

7. The photographic objective as claimed in one of claims 1 to 5, wherein the lens (8) is inserted into the barrel (15).

8. (canceled)

9. (canceled)

10. A panoramic camera comprising a photographic objective comprising a first (4) and at least one second mirror (5) and at least one lens (8), wherein a barrel (7; 7, 11; 15), in which the lens (8) is anchored, is formed by a supporting body (3) of the first mirror (4) wherein, with the exception of its front lens (8), the lenses (13) of a lens system are mounted in an intermediate barrel (12) which is inserted into the barrel (11; 15) of the mirror (3).
